(19) United States
(12) Patent Application Publication
(10) Pub. No.: US 2017/0030530 A1
(43) Pub. Date: Feb. 2, 2017

(54) METHOD AND ASSEMBLY FOR REPLACING INCANDESCENT LIGHTS

(71) Applicant: Curtis Alan Roys, Fredericksburg, TX (US)

(72) Inventor: Curtis Alan Roys, Fredericksburg, TX (US)

(21) Appl. No.: 15/219,049

(22) Filed: Jul. 25, 2016

Related U.S. Application Data
(60) Provisional application No. 62/196,798, filed on Jul. 24, 2015.

(51) Int. Cl. F21K 9/235; F21V 3/04; F21V 23/06; F21V 15/01; F21K 9/238; F21V 23/00; F21K 9/232; F21V 17/00

(52) U.S. Cl. CPC F21K 9/235; F21K 9/232; F21V 3/04; F21V 17/002; F21V 15/01; F21K 9/238; F21V 23/003; F21V 23/06; F21Y 2115/10

(57) ABSTRACT

A lamp base that fits into an incandescent lamp holder and accepts an LED support structure onto which LEDs can be mounted. A driver preferably in the lamp base provides power through a connector to the LEDs. Different LED support structures can be inserted and removed from the lamp base to customize the LED lamp. In some embodiments, customized lamp covers can be installed over the LEDs. In some embodiments, the LEDs are pre-mounted on the LED support structures. In some embodiments, the LED support structure can be cut to a desired length. In some embodiments, the pre-mounted LEDs are on a chain that is configured to be terminated when the LED support structure is cut to the desired length. In other embodiments, the LED chain is cut to length and then mounted on the LED support structure that is cut to length.

### CROSS-REFERENCE TO RELATED APPLICATIONS

The present application claims priority from U.S. Patent Application No. 62/196,798, filed on Jul. 24, 2015, which is hereby incorporated by reference.

### TECHNICAL FIELD OF THE INVENTION

Fluorescent and incandescent lamps have provided light for generations. Incandescent lamps often include an industry standard Edison lamp base, for example, as described in ANSI C81.61 and that screws into an Edison screw lamp holder as described, for example, in ANSI C81.62. Incandescent lighting operates by flowing electricity through a filament inside a glass bulb. The filament heats up and glows and that generates light. However, this technology creates a lot of heat. The incandescent light bulb loses 98% of its energy producing heat, making it quite inefficient. On Jan. 1, 2014, in keeping with a law passed by Congress in 2007, the 40- and 60-watt incandescent light bulbs can no longer be manufactured in the U.S., because they don't meet federal energy-efficiency standards. It's the last part of a gradual phase-out that began in 2012 with 100-watt bulbs, and progressed with discontinuation of the 75-watt variety.

Fluorescent lights are low pressure mercury-vapor gas-discharge lamps that use fluorescence to produce visible light. An electric current in the gas excites mercury vapor which produces short-wave ultraviolet light that then causes a light-emitting phosphor coating on the inside of the bulb to glow.

Compact fluorescent bulbs are replacing incandescent bulbs because the cost savings when using fluorescent lamps tend to be significant when compared to the cost of incandescent light use. However, recent developments in light emitting diode (LED) technology have made LEDs more efficient and cheaper to use than both fluorescent bulbs and incandescent bulbs. LEDs, a type of solid-state lighting, use a semiconductor to convert electricity into light. LEDs have many advantages over incandescent light sources and fluorescent light sources including lower energy consumption, longer lifetime, emitting an intended color without using any color filters, higher shock resistance, smaller size, and faster switching.

A light bulb's efficiency, or luminous efficacy, is a measure of emitted light, or lumens (lm), divided by the power it draws, or watts (W). A bulb that is 100% efficient at converting energy into light would have an efficacy of 683 lm/W. To illustrate, for example, a 60 W to 100 W watt incandescent bulb has an efficacy of 15 lm/W; an equivalent fluorescent light has an efficacy of 73 lm/W, and current LED-based replacement bulbs on the market range from 70 lm/W to 120 lm/W with an average efficacy of 85 lm/W.

The carbon footprint of LED use is significantly less than both incandescent lighting and fluorescent lighting. For example, if an average light bulb is on for 10 hours a day, a 40-watt bulb will cause 196 pounds of CO₂ emission per year. The 6-watt LED equivalent will only cause 30 pounds of CO₂ emission per year. Changing fluorescent lighting to LED lighting would give a 34% reduction in electrical power use around the world and reduce carbon emissions.

As illustrated in FIG. 1, many LED lamps are manufactured to replace screw-in incandescent or compact fluorescent light bulbs by using standard light bulb connections and shapes, such as an Edison screw base. Because the Edison screw base typically accommodates an incandescent bulb, the power supplied to the Edison screw base is typically line voltage, that is, 110 VAC to 120 VAC, in the United States. LED replacements that screw into the Edison base therefore typically include a small LED driver to convert line AC voltage to the low voltage DC typically required for operation of an LED and preferably to maintain a constant current to the LEDs. Such replacement LEDs are not customizable and sold as an assembly with the LED attached. The luminescence, shape, and color is fixed for each LED bulb at manufacturing and cannot be altered or customized by a purchaser.

A more flexible and easier method of replacing fluorescent bulbs and incandescent bulbs with LEDs in incandescent fixtures is desirable.

### SUMMARY OF THE INVENTION

An object of the invention is to provide a system, method and kit for easily installing customizable LED lamps into existing incandescent lamp fixtures.

Some embodiments of the invention use a lamp base that can be inserted into a conventional lamp holder, such as an Edison lamp holder. The lamp base accepts interchangeable LED support members upon which one or more LEDs of different types or colors are mounted. An LED driver in the lamp base powers the LEDs on the LED support member. The LED support members can be of different lengths and shapes, but include an LED support connector positioned on one end that mates with a lamp base which supports and provides power to the LEDs on the LED support structure. Interchangeable lamp covers, supported by the lamp base or by the LED support structure, cover the LEDs, allowing the appearance of the LED lamp to be changed. By providing interchangeable LED support members and lamp covers, a user can customize the LED lamp to provide a desired amount and color of light and a desired appearance.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 illustrates common LED bulb base types used;

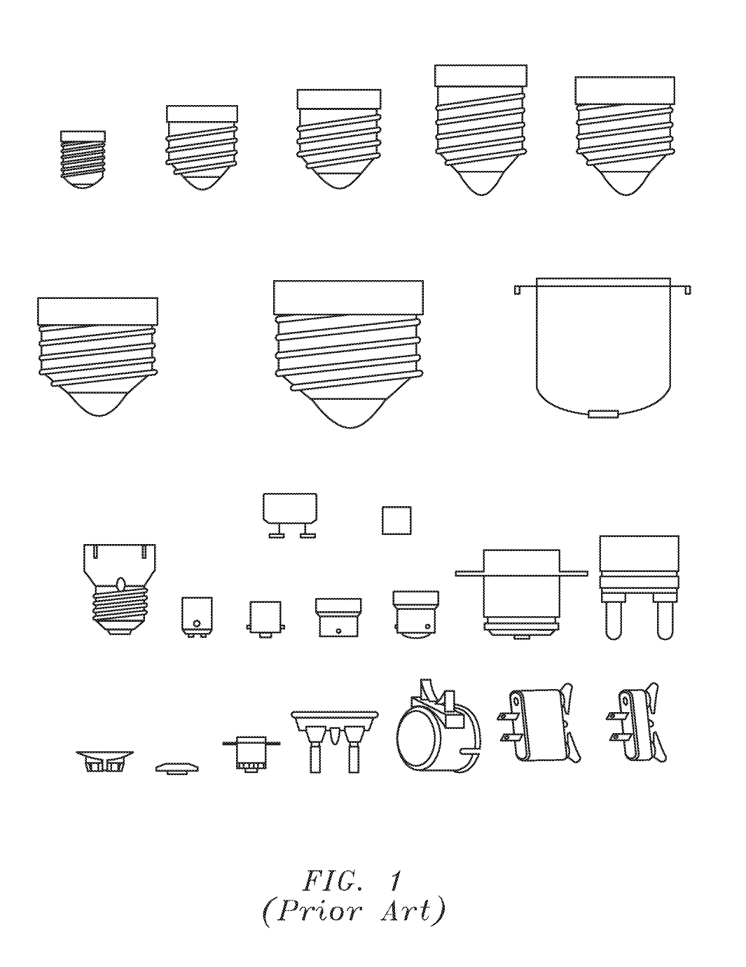

FIGS. 2A-2D illustrate an embodiment of the invention that replaces incandescent lightbulbs in common incandescent fixtures;

FIG. 3 is a flow chart which describes a method of replacing fluorescent lightbulbs with the LED replacement structure of FIG. 2A; and

FIG. 4 shows a kit that includes an LED support connector, an LED support structure, multiple LEDs mounted on the LED support structure, and a lamp base.

### DETAILED DESCRIPTION OF THE PREFERRED EMBODIMENTS

As used herein, the term “lamp” means an assembly that provides light. The “lamp holder” means a socket or other structure into which the lamp is secured during use. A “lamp base” is the portion of the lamp that is inserted into the lamp holder. A “lamp cover” is a structure between at least some of the LEDs and the environment and can comprise, for example, a globe or a lamp shade.

LED replacements for incandescent lamps are described.

Some embodiments provide a universal adapter to enable the installation of any size, type, color or quantity of LEDs into a conventional Edison screw-type lamp holder, plug-in lamp holder, or other type of lamp holder. In some embodiments, common screw or plug-in bases will contain an LED driver circuit to convert line voltage, such as 110 VAC, to 5 VDC, 12 VDC, 24 VDC or other voltage required by the LEDs at a constant current, but the base will remain the same form factor as current incandescent bases. A connector on one end of the LED support structure connects to a mating connector in the lamp base.

Some embodiments include a screw-in lamp base which includes a connector comprising a socket that accepts an LED support structure, such as a rod, onto which a number of LEDs can be mounted. Power to the LEDs can be supplied, for example, via connector prongs that receive power from an LED driver in the lamp base through mating electrodes in the socket. That is, the socket in the lamp base provides mechanical support and, in some embodiment, electric power, to the rod that supports the LEDs. Alternatively, the socket may provide only mechanical support, and power for the LED may be supplied by an external driver separate from the base.

In some embodiments, the base has a connector that will accept a 2-pronged connector attached to the LED light support structure which is inserted into the corresponding common socket worldwide. An extruded 3-sided plastic stick will contain LEDs on all three sides to eliminate dark spots. The LED lighting strip has 2 prongs that will slide into the electrical base for electrical connectivity. The LED support structure can be of any shape and material.

Since the LED base is universal, it can be fitted to common incandescent light fixtures for quick and easy installation by a consumer. In some embodiments, an end user can change the LED support structure to a support structure of a different length supporting a different number, type, or color of LEDs without having to purchase multiple LED light bulbs. The complete packaged base provides a universal LED adapter for incandescent lighting fixtures. The LED stick can be covered with any lamp cover to make it suitable for any ambience or suitable decor. The lamp cover can include one or more clips that attach the lamp cover to the lamp base or to the LED support structure. To applicant's knowledge, there is no current technology that simplifies the installation of LED lighting into incandescent lighting fixtures.

Embodiments of the current invention differ from customary LED replacement light bulbs. This invention allows the use of any size, length, shape or color LED into a common incandescent lamp base. The simplicity allows installation without the need to rewire any incandescent fixture and provides the ability to mass produce blister packs to be sold in the retail market worldwide that allow for installation of customized LEDs. In some embodiments, the LED support structure can be cut to a desired length by the consumer and so can be used in any size incandescent fixture such as tall, short or irregularly shaped decorator lamps, including ceiling fans and recessed lighting fixtures in the home. When cut to length, the conductors on the LED support structure maintain connections to the LEDs on the portion of the support structure that plugs in to the lamp base and the other end of the conductors are safely terminated. This invention will enable the end user to inexpensively install customized LED lighting in any incandescent fixture in any residential or commercial building, reducing electrical power consumption around the world.

Various embodiments of the invention include methods for replacing incandescent lightbulbs with LEDs, kits for converting incandescent lighting to LED lighting, and an apparatus for replacing incandescent lightbulbs with LEDs and the various components.

Some embodiments provide a method of replacing incandescent lightbulbs comprising optionally cutting a material to a determined length; attaching at least one LED to at least one side of the cut-to-length material; attaching a connector to one side of the cut-to-length material; and fitting the cut-to-length material with the attached at least one LED to an incandescent base.

Some embodiments provide an LED lamp comprising a first LED support structure; multiple LEDs mounted on the LED support structure; an LED support connector positioned on one end of the LED support structure and a lamp base, the lamp base including a first lamp base connector for mating with a lamp holder and a second lamp base connector for removably mating with the LED support connector.

Some embodiments provide an LED lamp kit providing a customizable LED lamp comprising an LED lamp, which includes one or more LED support structures; multiple LEDs mounted or mountable on the LED support structure; an LED support connector positioned on one end of each of the LED support structures. In some embodiments, the LED lamp kit includes a lamp base having a lamp base connector configured to mate with a lamp holder and second lamp base connector configured to mate with LED support connectors, and multiple lamp covers that can be interchangeably mounted onto the lamp base or onto the LED support structure for providing different appearances of the LED. In some embodiments, the LED lamp kit includes one or more additional LED support structures, each having multiple LEDs mounted thereon, that can be interchangeably mounted onto the lamp base.

Some embodiments provide a method of providing an LED lamp into an incandescent lamp holder comprising providing a lamp base, attaching a removable LED support structure to the lamp base, which includes a connector for supporting the LED support structure and for providing power through the connector, and attaching the lamp base into a lamp holder.

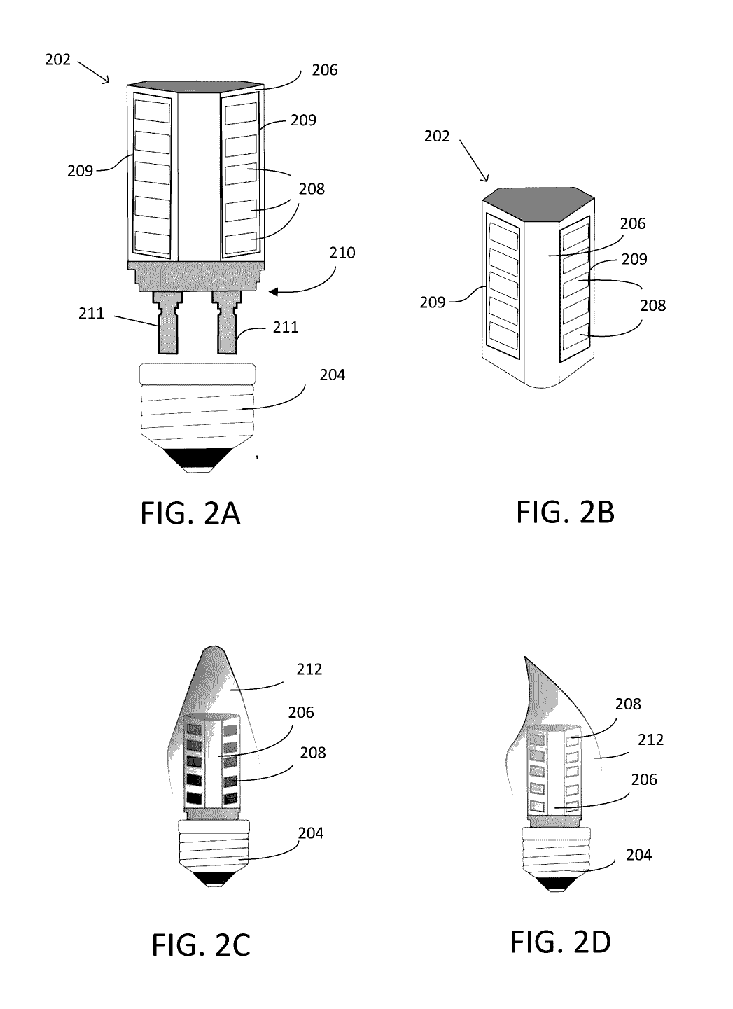

FIGS. 2A-2D show an embodiment of the invention. FIG. 2A illustrates a first LED support structure 202 that fits into a lamp base 204. The first LED support structure includes a six-sided rod of material 206 having LEDs 208 on three of the six sides. In other embodiments, the piece of material can have any number of sides. The material can be PVC, plastic, metal, or other material. If metal, the electrical circuits must be insulated from the material. The first LED support structure 202 has multiple LEDs 208 attached to the three sides of the material. In some embodiments, the first LED support structure has LEDs attached to more or fewer than three sides of the material. The electrical circuits 209 that supply power to the LEDs may comprise printed circuit boards 209, rigid or flexible, on which the LEDs can be mounted. The first LED support structure 202 also includes an LED support connector 210 positioned on one end of the LED support structure 202 to allow insertion of the first LED support structure 202 into a lamp base 204. Support connector 210 comprises a plug having two electrodes 211 that plug into mating receptacles (not shown) in lamp base 204. Lamp base 204 include an LED driver that converts the line voltage, typically 110V-120V, delivered to lamp base 204 when it is screwed in to a receiving lamp socket, to the appropriate voltage for the LED, typically 12 V, which is provided through electrodes 211 to LEDs 208 through circuit 209.

Alternatively, the LED driver can be located in support connector 210, which can receive line voltage from lamp base 204 and convert the line voltage into a voltage appropriate for LEDs 208. Material 206 with LEDs 208 may be permanently attached to support connector 210 to provide a replaceable sub-assembly unit that can be plugged into lamp base 204. Support connector can be formed integral with material 206, as one piece instead of as two separate pieces.

The lamp base 204 can then be screwed into the corresponding incandescent lamp holder such as, but not limited to, tall, short, or irregularly shaped decorator lamps, ceiling fans, or recessed lighting fixtures in the home.

Embodiments of the invention eliminate the need to rewire the incandescent fixture to provide LED lamps. Embodiments of the invention eliminate the requirement to purchase or stock complete LED of various sizes or shapes by providing multiple LED support structures that can be inserted into a common lamp base. Embodiments of the invention can also be mass produced in blister packs to be sold to consumers.

FIG. 2B shows an angled view of the LED support structure 202 in FIG. 2A. FIGS. 2C and 2D show the LED support structure attached to a lamp base 204 with various lamp covers 212 covering the multiple LEDs 208 on the LED support structure 202.

In some embodiments, the LED support structure is not in an encasement or cover and the LEDs mounted thereon emit a desired color of light. In some embodiments, the LED portion emits a desired color and quantity of light, and is housed in an encasement or cover to protect the LED light structure or alter the color or intensity of the light. In some embodiments, the LED portion emits a standard white color and the encasement is colored to change the light emitted. In some embodiments, the LEDs are omnidirectional or flood LEDs.

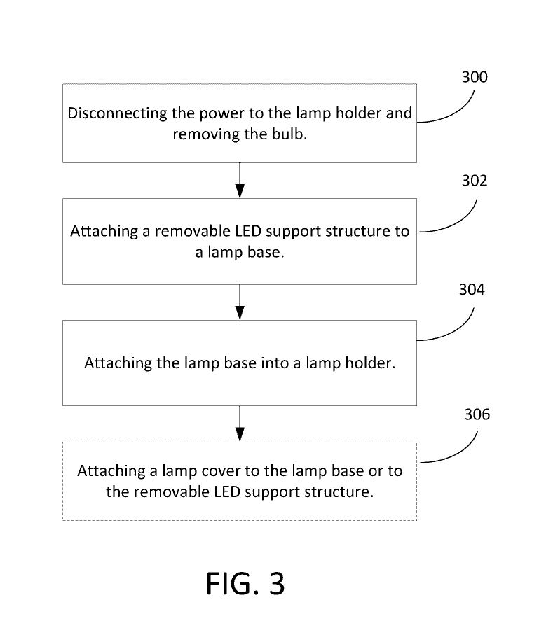

FIG. 3 is a flow chart which describes a method of providing an LED lamp in an incandescent lamp holder as depicted in FIGS. 2A-2D. In Step 300, the power to a lamp holder is disconnected and the incandescent bulb is removed. In step 302, a removable LED support structure is attached to a lamp base. The removable LED support structure may include a rod having LEDs mounted on the rod and an LED support connector that plugs into the lamp base. In step 304, the lamp base is attached to a lamp holder, for example, by screwing the lamp base into the Edison lamp holder. In optional step 306, a lamp cover is attached to the lamp base or to the removable LED support structure. This process allows LED replacement of incandescent bulbs without the need to remove the entire fixture.

In some embodiments, the LEDs and the connector can be attached to the tube with an adhesive, such as glue, tape, epoxy, or a similar compound. In some embodiments, the connector and the material include a threading allowing the connector to screw onto the ends of the material.

The LED support structure can be plastic, metal, ceramic, or other tubing of any materials or cross-sectional shape. These shapes include, for example, cylindrical, triangle-shaped, square-shaped, and hexagonal-shaped. The LED support structure can be hollow or a solid material. A kit in accordance with some embodiments of the invention can include connectors, LEDs with a means for attaching to the tube, and a power supply for the LEDs. The LEDs can be attached to the tube using adhesives or mechanical fasteners. A kit can include LEDs pre-mounted to the tubes. The kit may include multiple tubes of different lengths and/or with different numbers or types of LED mounted thereon. Alternatively, a single tube can be cut to a desired length and then the LEDs can be mounted thereon. The tube can be pre-scored, perforated, or otherwise constructed so that it can be easily broken or cut to the desired length.

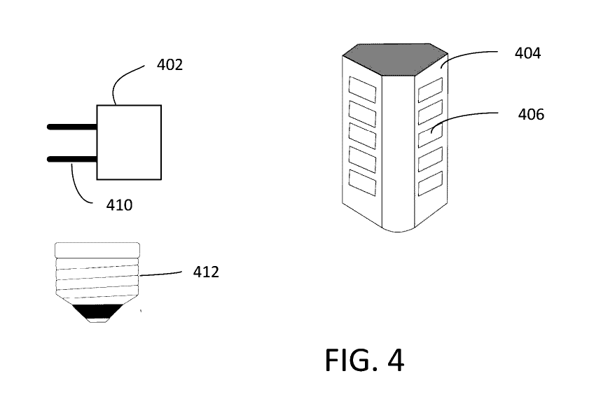

FIG. 4 shows a kit that includes an LED support connector 402, an LED support structure 404, multiple LEDs 406 mounted on the LED support structure 404, and a lamp base 412.

The LED support connector is adapted to be connected to the lamp base without screws or other connectors as described above. This facilitates connecting the connector to the LED support structure rather than requiring the connector to be attached to the LED support in a factory as in prior art LED strips. The LED support connector can have electrodes or pins 410 or other extensions that fit into any common incandescent lightbulb base 412. The kit may include an LED support-connector subassembly in which an LED support connector is permanent attached to support structure 404 as shown in FIG. 2A. The kit may include multiple support-connector subassemblies, in which the support assemblies have deferring or the same lengths.

According to some embodiments of the invention, an LED lamp, comprises a first LED support structure; multiple LEDs mounted on the LED support structure; an LED support connector positioned on one end of the LED support structure; and a lamp base, the lamp base including a first lamp base connector for mating with a lamp holder and a second lamp base connector for removably mating with the LED support connector.

In some embodiments, the LED lamp further comprises a circuit between the lamp base and the multiple LEDs for converting alternating current line voltage from the lamp base to provide direct current to the multiple LEDs. In some embodiments, the circuit for converting alternating current line voltage to direct current to provide the multiple LEDs is positioned in the lamp base. In some embodiments, the LED support connector includes two pins for receiving power from the second lamp base connector to provide power for the multiple LEDs.

In some embodiments, the LED lamp further comprises a lamp cover covering the LEDs. In some embodiments, the lamp cover comprises a transparent or translucent glass or plastic cover. In some embodiments, the lamp cover comprises a lamp shade. In some embodiments, the lamp cover comprises both a lamp shade and a transparent or translucent glass or plastic cover. In some embodiments, the lamp cover is mounted on the first LED support structure.

In some embodiments, the first LED support structure comprises a metal, ceramic or a plastic rod. In some embodiments, the first LED support structure is cylindrical, triangle-shaped, square-shaped, or hexagonal-shaped. In some embodiments, the first LED support structure comprises a first portion on which the LED support connector and a second portion that can be removed to change the length of the first LED support structure.

According to some embodiments of the invention, an LED lamp kit providing a customizable LED lamp, comprises an LED lamp comprising a first LED support structure; multiple LEDs mounted on an LED support structure; an LED support connector positioned on one end of the LED support structure; and a lamp base, the lamp base including a first lamp base connector for mating with a lamp holder and a second lamp base connector for removably mating with the LED support connector, and multiple lamp covers that can be interchangeably mounted onto the lamp base or onto the LED support structure for providing different appearances of the LED. In some embodiments, the multiple lamp covers have different colors or different shapes.

According to some embodiments of the invention, an LED lamp kit providing a customizable LED lamp, comprises an LED lamp, which includes a first LED support structure; multiple LEDs mounted on LED support structure; an LED support connector positioned on one end of the LED support structure; and a lamp base, the lamp base including a first lamp base connector for mating with a lamp holder and a second lamp base connector for removably mating with the LED support connector; and one or more additional LED support structures, each having multiple LEDs mounted thereon, that can be interchangeably mounted onto the lamp base.

In some embodiments, at least some of the one or more additional LED support structures have a different number of LEDs from the number of LEDs on the first LED support structure. In some embodiments, at least some of the one or more additional LED support structures have a length different from the length of the first LED support structure.

In some embodiments, the LED lamp kit further comprises one or more LED covers configured to be mounted onto the LED base or onto one of the LED support structures.

According to some embodiments of the present invention, a method of providing an LED lamp into an incandescent lamp holder, comprises attaching a removable LED support structure to a lamp base, the lamp base including a connector for supporting the LED support structure and for providing power through the connector; and attaching the lamp base into a lamp holder.

In some embodiments, the method further comprises attaching a lamp cover to the lamp base or to the removable LED support structure. In some embodiments, attaching a lamp cover to the lamp base or to the removable LED support structure includes attaching a removable transparent or translucent glass or plastic cover. In some embodiments, attaching a lamp cover to the lamp base or to the removable LED support structure includes attaching a removable lamp shade. In some embodiments, the method further comprises disconnecting the power to the lamp holder and removing an incandescent bulb from the holder.

Although the present invention and its advantages have been described in detail, it should be understood that various changes, substitutions and alterations can be made to the embodiments described herein without departing from the scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A light emitting diode (LED) lamp, comprising:
an LED support structure;
multiple LEDs mounted on LED support structure;
an LED support connector positioned on one end of the LED support structure; and
a lamp base, the lamp base including a first lamp base connector for mating with a lamp holder and a second lamp base connector for removably mating with the LED support connector.

2. The LED lamp of claim 1 further comprising a circuit between the lamp base and the multiple LEDs for converting alternating current line voltage from the lamp base to provide direct current to the multiple LEDs.

3. The LED lamp of claim 2 in which the circuit for converting alternating current line voltage to direct current to provide the multiple LEDs is positioned in the lamp base.

4. The LED lamp of claim 1 in which the LED support connector includes two pins for receiving power from the second lamp base connector to provide power for the multiple LEDs.

5. The LED lamp of claim 1 further comprising a lamp cover covering the LEDs.

6. The LED lamp of claim 5 in which the lamp cover comprises a transparent or translucent glass or plastic cover.

7. The LED lamp of claim 5 in which the lamp cover comprises a lamp shade.

8. The LED lamp of claim 5 in which the lamp cover comprises both a lamp shade and a transparent or translucent glass or plastic cover.

9. The LED lamp of claim 5 in which the lamp cover is mounted on the first LED support structure.

10. The LED lamp of claim 1 in which the first LED support structure comprises a metal or a plastic.

11. The LED lamp of claim 1 in which the first LED support structure is cylindrical, triangle-shaped, square-shaped, or hexagonal-shaped.

12. The LED lamp of claim 1 in which the first LED support structure comprises a first portion on which the LED support connector and a second portion that can be removed to change the length of the first LED support structure.

13. An LED lamp kit providing a customizable LED lamps, comprising:
an LED lamp according to claim 1; and
multiple lamp covers that can be interchangeably mounted onto the lamp base or onto the LED support structure for providing different appearances of the LED.

14. The LED lamp kit of claim 13 in which the multiple lamp covers have different colors or different shapes.

15. An LED lamp kit providing a customizable LED lamp, comprising:
an LED lamp according to claim 1; and
one or more additional LED support structures, each having multiple LEDs mounted thereon, that can be interchangeably mounted onto the lamp base.

16. The LED lamp kit of claim 15 in which at least some of the one or more additional LED support structures have a different number of LEDs from the number of LEDs on the first LED support structure.

17. The LED lamp kit of claim 15 in which at least some of the one or more additional LED support structures have a length different from the length of the first LED support structure.

18. The LED lamp kit of claim 15 further comprising one or more LED covers configured to be mounted onto the LED base or onto one of the LED support structures.

19. A method of providing an LED lamp into an incandescent lamp holder, the method comprising:
attaching a removable LED support structure to a lamp base, the lamp base including a connector for supporting the LED support structure and for providing power through the connector; and
attaching the lamp base into a lamp holder.

20. The method of claim 19 further comprises attaching a lamp cover to the lamp base or to the removable LED support structure.

21. The method of claim 20 in which attaching a lamp cover to the lamp base or to the removable LED support structure includes attaching a removable transparent or translucent glass or plastic cover.

22. The method of claim 20 in which attaching a lamp cover to the lamp base or to the removable LED support structure includes attaching a removable lamp shade.

23. The method of claim 19 further comprising disconnecting the power to the lamp holder and removing an incandescent bulb from the holder.
